(19) United States
(12) Patent Application Publication
(10) Pub. No.: US 2013/0321137 A1
(43) Pub. Date: Dec. 5, 2013

(54) WARNING DEVICE FOR A MOTOR VEHICLE HAVING AT LEAST ONE ELECTRICALLY MOVABLE CLOSING ELEMENT FOR A VEHICLE OPENING

(71) Applicant: GM GLOBAL TECHNOLOGY OPERATIONS LLC, Detroit, MI (US)

(72) Inventor: Thomas DEGENSTEIN, Mainz (DE)

(21) Appl. No.: 13/897,751

(22) Filed: May 20, 2013

(30) Foreign Application Priority Data
Jun. 5, 2012 (DE) 10 2012 011 153.3

(51) Int. Cl. B60Q 9/00

(52) U.S. Cl. CPC B60Q 9/00
USPC 340/438

(57) ABSTRACT

A warning device for a motor vehicle having at least one vehicle aperture, which comprises an electrically movable closure element, is provided. The warning device includes a position detector for detecting a position of the closure element, an evaluation unit for detecting a closing command of the motor vehicle and generating a warning signal if with the closing command an opened position of the closure element is sensed, a warning signal generator for outputting a warning signal, and a function operation device coupled to the evaluation unit for outputting the closing command and on which the warning signal generator is arranged.

### CROSS-REFERENCE TO RELATED APPLICATION

This disclosure claims priority to German Patent Application No. 10 2012 011 153.3, filed Jun. 5, 2012, which is incorporated herein by reference in its entirety.

### TECHNICAL FIELD

The technical field relates to a warning device for a motor vehicle having a vehicle aperture, which comprises an electrically movable closure element, which warns a user of the motor vehicle as reaction to a closing command, in particular to a closing command output via a function operation of the motor vehicle, if a closure element is still in an opened position.

### BACKGROUND

Usual motor vehicles are increasingly equipped with driver assistance or driver support systems, which free the user of the motor vehicle of routine tasks in order to increase the comfort and the pleasure when driving the vehicle while increasing the safety at the same time.

Before the background of securing the vehicle against unauthorized entry and above all against theft, such systems increasingly influence the use or the purchase decision of consumers as well.

For example when closing a motor vehicle, in particular via its central locking system by means of a function operation, it is desirable, in addition to a locking of the vehicle doors and of the trunk lid, to signal to a user that one or a plurality of vehicle apertures are still opened and to activate the motoric drives for example of still opened windows or of an open sliding roof if applicable by a central control, moving these into their closed position if so desired. However, if closing operations for vehicle apertures which are not closed were not successful or if a responding of a jamming protection device resulted in a reversing of the closing operation with the consequence that these function elements remain at least partially opened is regularly not indicated to the user here, a presumably closed and locked vehicle is exposed to an increased theft risk and by way of the still opened vehicle apertures also to weather influences, for example in the form of rain entering the motor vehicle.

From the publication DE 10 2009 034 919 A1 a warning device for a motor vehicle is known, which outputs a warning instruction in the vehicle interior if as reaction to an indication of an imminent exit of a user from the motor vehicle it is detected that a closure element for a vehicle aperture is still in an opened position.

It is at least one object herein to provide a warning device for a motor vehicle, with which it can be reliably and discretely signaled to a user of the motor vehicle even when closing the motor vehicle by a function operation that a closure element is still in an opened position. In addition, other objects, desirable features and characteristics will become apparent from the subsequent summary and detailed description, and the appended claims, taken in conjunction with the accompanying drawings and this background.

### SUMMARY

According to an embodiment, a warning device for a motor vehicle having at least one vehicle aperture is provided. The warning device has an electrically movable closure element, with a position detector for detecting a position of the closure element, an evaluation unit for detecting a closure command of the motor vehicle and generating a warning signal if with detected closure command an open position of the closure element is sensed, and a warning signal generator for outputting the warning signal. Here, the warning device furthermore comprises a function operation coupled to the evaluation unit for outputting the closing command and on which the warning signal generator is arranged.

Thus, the basic idea is to give a user of the motor vehicle a clearly interpretable feedback regarding the state of vehicle apertures following the output of a closing command via a function operation device, i.e., to draw the user's attention that one or a plurality of vehicle apertures are not or are not completely closed up.

Such a warning device has the advantage that it can be reliably and discretely signaled to a user of the motor vehicle even when closing or locking the motor vehicle by a function operation device that a closure element for a vehicle aperture is still in an opened position. This suggests to a user of the motor vehicle to abort the actuation of the function operation device if applicable, since one or a plurality of vehicle apertures are still opened. The user can now close the still opened vehicle apertures of the presumably closed and locked motor vehicle, which results in a substantially reduced theft risk and in reduced weather influences, for example of rain, which can enter the vehicle through an opened vehicle aperture. Opened position of the closure elements in this case is to mean that the closure element does not or only partially covers the respective vehicle aperture. Closure element furthermore is to mean elements or vehicle parts which close off a vehicle aperture towards the outside if required.

The vehicle aperture in this case can be a window of the motor vehicle and/or a sliding roof and/or a folding top. Information regarding all vehicle apertures which are usually provided with an electrically movable closure element can thus be made available to the user, thus also regarding those which he cannot directly see for example because of poor light conditions, when a side of the motor vehicle is not accessible because the motor vehicle for example is parked against a wall with that side or if when using the function operation device the distance between user and motor vehicle is so great that the user can no longer directly see all vehicle apertures.

According to an embodiment, the position detector is an end position sensor. Such an end position sensor can determine with utmost accuracy when the electrically movable closure element reaches one or the other end position, i.e. completely or not at all covers the vehicle aperture, and in response to this outputs an end position signal to the evaluation unit. These can also be simply integrated in the motor vehicle without elaborate and costly conversions being necessary in the process.

According to a further embodiment, the position detector can also be configured for detecting an increase of the current consumption of an operating element of the electrically movable closure element. In the case of electrically movable closure elements for vehicle apertures, the switching-off of a drive of the closure element is effected via a current measurement. Thus, on reaching an end position, when the closure element is in a closed position, i.e., completely covers the vehicle aperture, the drive is briefly blocked which results in an increase of the current consumption. Thus, the position of an electrically movable closure element for a vehicle aperture can be reliably sensed without major effort.

Furthermore, the warning signal generator can be configured for generating an acoustic warning signal, in accordance with an embodiment. Acoustic signal generators are known with usual motor vehicles in order to draw the attention of road users to the criticality of a corresponding situation by generating an acoustic signal, by way of which the road users can be prompted to suitably alleviate the critical situation. The acoustic signal in this case is, for example, a sound or a sound sequence, which is configured to discretely point out to the user of the motor vehicle that at least one vehicle aperture is not completely closed without this advice being perceived as unpleasant or interfering by the user and/or his surroundings. Through the non-interfering warning function, the sense of comfort can be advantageously increased in particular in situations in which the user would like to or has to avoid obvious acoustic advice.

In another embodiment, the warning signal generator is configured for generating a visual warning signal. Visual warning signals have the advantage that these are also perceived before a loud background noise for example caused through traffic noise and can advise the user that vehicle apertures are not completely closed.

Here, the warning signal generator can comprise an illumination element and the warning signal can be a flashing of the illumination element. Through illumination elements arranged in the field of vision of the user, any vehicle apertures that have not been closed can be brought to the attention of the user in a particularly discrete manner.

The warning signal generator can also comprise a display unit and the warning signal can be an error message displayed on the display unit. The display unit in this case is configured, for example, as an illuminated LCD display, on which the warning signal is symbolically displayed. As an indication of a vehicle aperture that has not been completely closed, the vehicle aperture concerned can be for example indicated symbolically or in plain text so that the user is enabled to suitably react, for example to completely close the vehicle aperture.

In a further embodiment, the warning signal generator is configured in order to generate further warning signals, for example a haptic warning signal.

The function operation device can be a remote control or a key switch. Usual motor vehicles are increasingly provided with such key switches or remote controls, by means of which when closing the motor vehicle via its central locking system, vehicle doors and the boot lid can be locked. Thus, it can be reliably and discretely signaled to a user of the motor vehicle during closing and locking by such function operation devices that one or a plurality of closure elements are still in an opened position. This is an indication to the user to abort the actuation of the function operation device if applicable, since vehicle apertures are entirely or partially still open, as a result of which weather influences, for example of rain, which enters the vehicle through the opened vehicle aperture, and the theft risk, can be reduced.

In an embodiment, the function operation device of the motor vehicle includes an operating element for triggering a movement of the closure element. This makes it possible for the user of the motor vehicle to immediately react to the indication, i.e. close any vehicle apertures which have not yet been completely closed. It is also ensured that the user during closing is located in the range of operation of the function operation device of the motor vehicle, thus in the vicinity of the motor vehicle. This is important for example when a closing closure element for a vehicle aperture for example jams in a part of a body of a person, which can lead to the responding of a jamming protection device and thus a reversing of the closing operation.

The control unit can also be coupled to a display of the motor vehicle in such a manner that it displays an indication on the display if with detected closing command an opened position of the closure element is sensed. The indication can in particular be assistance for the user of the motor vehicle, for example information regarding the type of the warning signal and possible further procedural steps. It proves to be helpful if the user cannot attribute the warning signal, for example when using the warning device for the first time.

In summary it must be noted that with such a warning device the theft risk can be substantially reduced and the risk of weather influences, for example, of rain entering the motor vehicle through a vehicle aperture, can be reduced, since it can be reliably and discretely signaled to a user of the motor vehicle even when closing or locking the motor vehicle via a function operation device that a closure element for a vehicle aperture is still in an opened position, as a result of which it is signaled to the user to abort the actuation of the function operation device if applicable and close vehicle apertures that are presumably closed and locked, for example, but which are not yet closed.

In addition, the sense of comfort with unimpeded warning function can be advantageously increased in that the warning signal generator is configured to generate as a warning signal a discrete indication tone or includes an illuminating element arranged in the field of vision of the user so that obvious acoustic and/or visual indications can be avoided.

The user can also directly and intuitively react to the warning signal, i.e., close any vehicle apertures that have not yet been completely closed off if applicable, since the function operation device of the motor vehicle can comprise an operating element for triggering a movement of the closure element of the respective vehicle aperture.

### BRIEF DESCRIPTION OF THE DRAWINGS

The various embodiments will hereinafter be described in conjunction with the following drawing figures, wherein like numerals denote like elements, and wherein:

FIG. 1 shows a schematic perspective oblique view of a motor vehicle with a warning device according to exemplary embodiments; and

FIG. 2 shows a block diagram of a warning device according to exemplary embodiments.

### DETAILED DESCRIPTION

The following detailed description is merely exemplary in nature and is not intended to limit the various embodiments or the application and uses thereof. Furthermore, there is no intention to be bound by any theory presented in the preceding background or the following detailed description.

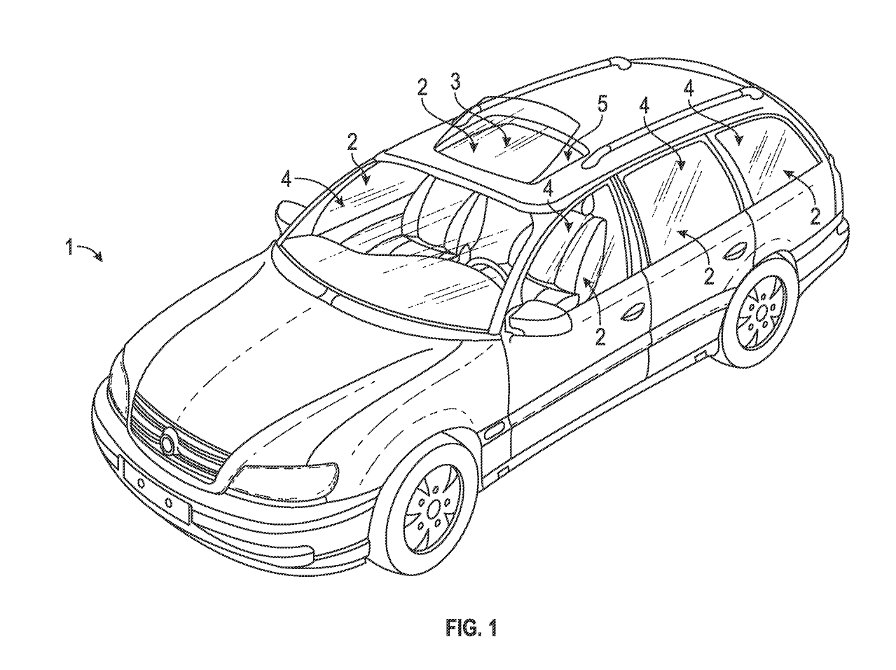

FIG. 1 shows a schematic perspective oblique view of a motor vehicle 1 having a warning device according to an exemplary embodiment.

As shown by FIG. 1, the vehicle 1 comprises a plurality of vehicle apertures 2 with electrically movable closure elements 3.

In detail, windows 4 of the motor vehicle 1 and a sliding roof 5 are visible as vehicle apertures 2. As shown by FIG. 1, the windows 4 are completely closed but the sliding roof 5 is in an opened position. Thus, the closure element 3 of the sliding roof 5 in the embodiment of FIG. 1 is in an opened position inclined relative to the vehicle aperture 2. Opened position in this case is to mean that the vehicle aperture 2 is not wholly or partially covered by the corresponding element 3. Closure element 3 is to mean further elements or vehicle parts which close off a vehicle aperture towards the outside if required.

Furthermore, the vehicle apertures 2 can also be a folding top.

The motor vehicle furthermore comprises a warning device which is not shown in FIG. 1 for detecting a closing command of the motor vehicle 1 and generating a warning signal if with detected closing command an opened position of an electrically movable closure element 3 is sensed, wherein the closing command is output via a function operation device of the motor vehicle 1 and a warning signal generator is arranged on the function of operation device.

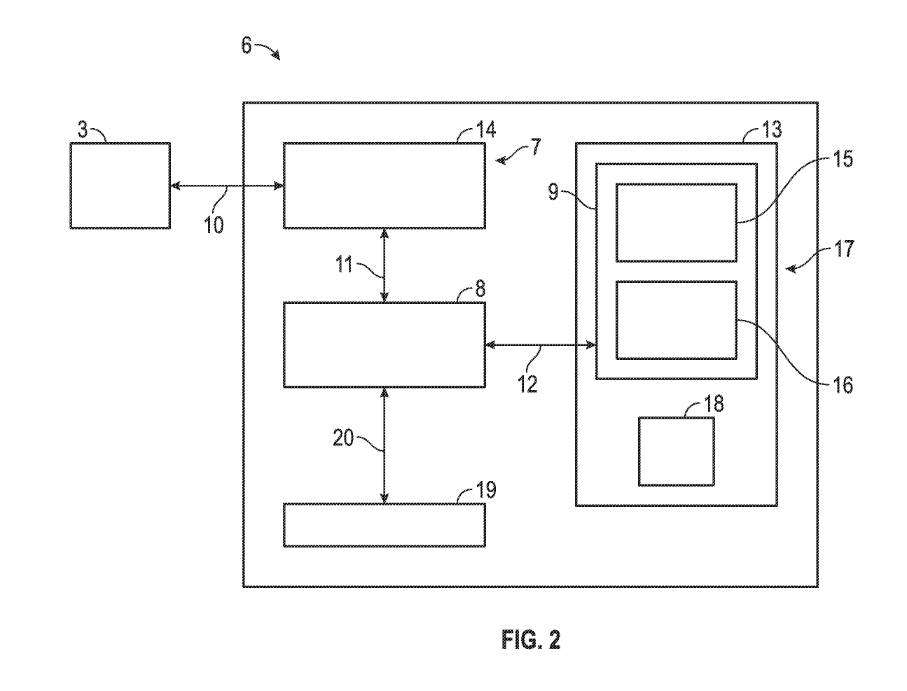

FIG. 2 shows a block diagram of a warning device 6 for a motor vehicle 1 having at least one vehicle aperture 2, which comprises an electrically movable closure element 3, according to an exemplary embodiment. Components and parts having the same function or design as in FIG. 1 have the same reference characters and are not explained in more detail.

As shown by FIG. 2, the warning device 6 comprises a position detector 7 coupled to the electrically movable closure element 3 for detecting a position of the closure element 3, an evaluation unit 8 coupled to the position detector 7 for detecting a closing command of the motor vehicle 1 and generating a warning signal if with detected closing command an opened position of the closure element 3 is sensed, and a warning signal generator 9 coupled to the evaluation unit 8 for outputting the warning signal. The coupling between position detector 7 and the closure element 3 in this case is symbolized by the arrow provided with reference number 10, the coupling between position detector 7 and evaluation unit 8 by the arrow provided with reference number 11 and the coupling between evaluation unit 8 and warning signal generator 9 by the arrow provided with reference number 12.

As is shown, furthermore, by FIG. 2, the warning signal generator 9 in this case is arranged on a function operation device 13 of the motor vehicle 1, via which the closing command can be output.

In an embodiment, the shown position detector 7 is an end position sensor 14. Such an end position sensor 14 can be determined with utmost accuracy when the electrically movable closure element 3 reaches its one or other end position, i.e. covers the vehicle aperture 2 completely or not at all, and thereupon output an end position signal to the evaluation unit 8.

Furthermore, the position detector 7 however can also be configured in order to detect an increase of the current consumption of an operating element of the electrically movable closure element 3. Thus, on reaching an end position, when the closure element 3 is in a closed position, i.e., completely covers the vehicle aperture 2, a drive of the closure element 3 is briefly blocked, which results in an increase of the current consumption.

The warning signal generator 9 in this case is configured in order to generate an acoustic warning signal, i.e., to generate as a warning signal a discrete tone or a discrete sequence of tones without this indication being perceived to be unpleasant or interfering by the user and/or its surroundings, as a result of which the sense of comfort with non-interfering warning function is advantageously increased.

The warning signal generator 9 of FIG. 2 is also configured in such a manner that it can generate a visual warning signal.

Thus, in an embodiment, the warning signal generator comprises an illumination element 15, wherein the warning signal is a flashing of the illumination element 15.

The shown warning signal generator 9 also comprises a display unit 16, wherein the warning signal is an error message displayed on the display unit 16. As indication of a vehicle aperture 2 which is not yet completely closed, the vehicle aperture 2 concerned can for example be indicated symbolically or in plain text, so that the user is enabled to suitably react for example to completely close the vehicle aperture 2.

However, in an embodiment the warning signal generator 9 can also be configured furthermore to generate further warning signals, for example a haptic warning signal.

The function operation device 13 of the motor vehicle of FIG. 2 is a remote control 17 of the motor vehicle 1. The coupling between the evaluation unit 8 of the warning device 6 and the remote control 17 in this case is again symbolized by the arrow marked with the reference number 12.

In another embodiment, the function operation device 13 can also be a key switch.

As is shown, furthermore, by FIG. 2, the function operation device 13 of the motor vehicle 1 comprises an operating element 18 for triggering a movement of the closure element 3. A user of the motor vehicle 1 is thus provided with the possibility of directly and intuitively reacting to the warning signal and to close any vehicle apertures 2 that have not yet been completely closed.

As is evident, in an embodiment, the evaluation unit 8 furthermore is coupled to a display 19 of the motor vehicle 1 in such a manner that an indication can be displayed on the display 19. The coupling between evaluation unit 8 and display 19 in this case is symbolized by the arrow marked with reference number 20. The indication in this case can be aids for the user of the motor vehicle 1, in particular information regarding the type of the warning signal and regarding possible further procedures. This is helpful in particular when the user cannot allocate the warning signal, for example when using the warning device 6 for the first time.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

1. A warning device for a motor vehicle having at least one vehicle aperture, which comprises an electrically movable closure element, the warning device comprising:
a position detector for detecting a position of the closure element;
an evaluation unit for detecting a closing command of the motor vehicle and generating a warning signal if, with the closing command, an opened position of the closure element is sensed;
a warning signal generator for outputting a warning signal; and
function operation device coupled to the evaluation unit for outputting the closing command and on which the warning signal generator is arranged.

2. The warning device according to claim 1, wherein the at least one vehicle aperture is a window of the motor vehicle and/or a sliding roof and/or a folding top.

3. The warning device according to claim 1, wherein the position detector comprises an end position sensor.

4. The warning device according to claim 1, wherein the position detector is adapted to detect an increase of current consumption of an operating element of the electrically movable closure element.

5. The warning device according to claim 1, wherein the warning signal generator is adapted to generate an acoustic warning signal.

6. The warning device according to claim 1, wherein the warning signal generator is adapted to generate an optical warning signal.

7. The warning device according to claim 6, wherein the warning signal generator comprises an illumination element and the warning signal is a flashing of the illumination element.

8. The warning device according to claim 6, wherein the warning signal generator comprises a display unit and the warning signal is an error message displayed on the display unit.

9. The warning device according to claim 1, wherein the function operation device is a remote control or a key switch.

10. The warning device according to claim 1, wherein the function operation device comprises an operating element for triggering a movement of the closure element.

11. The warning device according to claim 1, wherein the evaluation unit is coupled to a display of the motor vehicle for displaying an indication on the display.
